(19) United States
(12) Patent Application Publication
(10) Pub. No.: US 2007/0012201 A1
(43) Pub. Date: Jan. 18, 2007

(54) Hotdog cooker

(76) Inventor: Wei-Teh Ho, Taipei (TW)

Correspondence Address: WE-TEH HO, P.O. BOX 24-108, TAIPEI, TW

(21) Appl. No.: 11/178,774

(22) Filed: Jul. 12, 2005

(51) Int. Cl. A47J 43/18

(52) U.S. Cl. 99/441

(57) ABSTRACT

A hotdog cooker is disclosed to include a pan with a handle, a roller rack, which is formed of parallel rollers arranged and a gear transmission mechanism and placed on the pan for carrying hotdogs for cooking, and a driving device, which can be a crank handle or battery-operated motor drive coupled to the gear shaft of one gear of the gear transmission mechanism for driving the rollers to rotate so as to turn hotdogs run and run in the roller rack for cooking.

### BACKGROUND OF THE INVENTION

1. Field of the Invention

The present invention relates to a cooking utensil and more particularly, to an economic hotdog cooker practical for home use.

2. Description of the Related Art

A hotdog is a smooth-textured sausage of minced beef or port usually smoked. Before eating a hotdog, it must be well cooked. Various hotdog cooking machines have been disclosed, and have appeared on the market. However, these hotdog cooking machines are commonly expensive, not practical for home use. A housekeeper may use a frying pan to cook hotdogs at home. However, it is difficult to turn hotdogs run and run in a frying pan during cooking, and hotdogs may be overroasted.

### SUMMARY OF THE INVENTION

The present invention has been accomplished under the circumstances in view. It is the main object of the present invention to provide a hotdog cooker, which is an economic cooking utensil practical for home use for cooking hotdogs.

To achieve this and other objects of the present invention, the hotdog cooker comprises a pan; a handle fixedly fastened to one side of the pan; a roller rack for carrying hotdogs on the pan for cooking, the roller rack comprising two side frame bars arranged in parallel, a plurality of rollers pivotally connected between the side frame bars and arranged in parallel, a plurality of first gears respectively fixedly mounted on the rollers adjacent to one of the side frame bars, and a plurality of second gears respectively meshed between the first gears at each two adjacent rollers of the rollers; and a driving means connected to a gear shaft of one of the first gears for rotating the respective first gear and the respective roller to drive the rollers to rotate. According to another aspect of the present invention, the driving means can be a crank handle or a battery-operated motor drive.

### BRIEF DESCRIPTION OF THE DRAWINGS

FIG. 1 is an elevational view of a hotdog cooker according to a first embodiment of the present invention.

FIG. 2 is an exploded view of the hotdog cooker according to the first embodiment of the present invention.

FIG. 3 is an elevational view of a hotdog cooker according to a second embodiment of the present invention.

FIG. 4 is an exploded view of the hotdog cooker according to the second embodiment of the present invention.

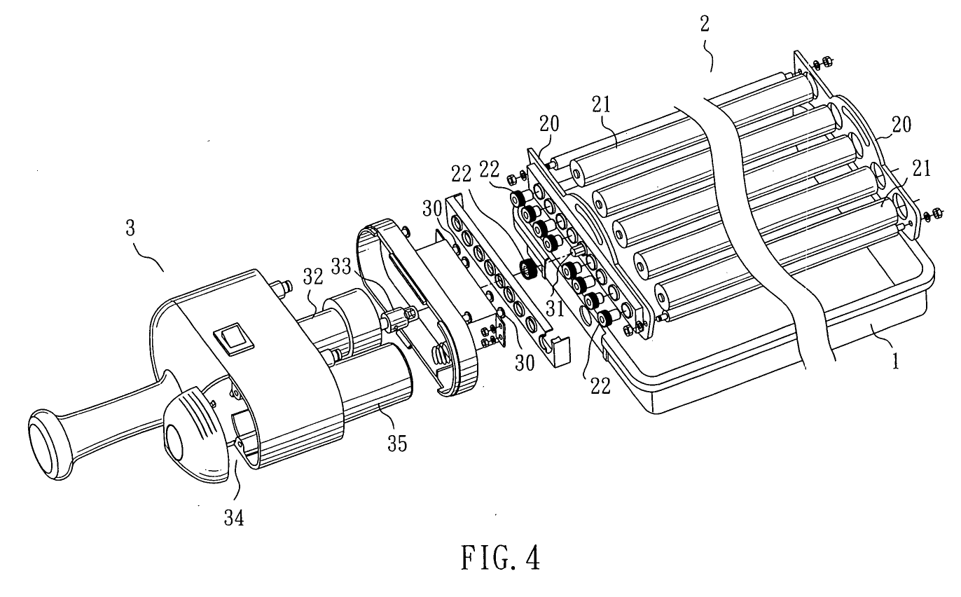

FIG. 5 is a perspective view in an enlarged scale of a part of the hotdog cooker according to the second embodiment of the present invention.

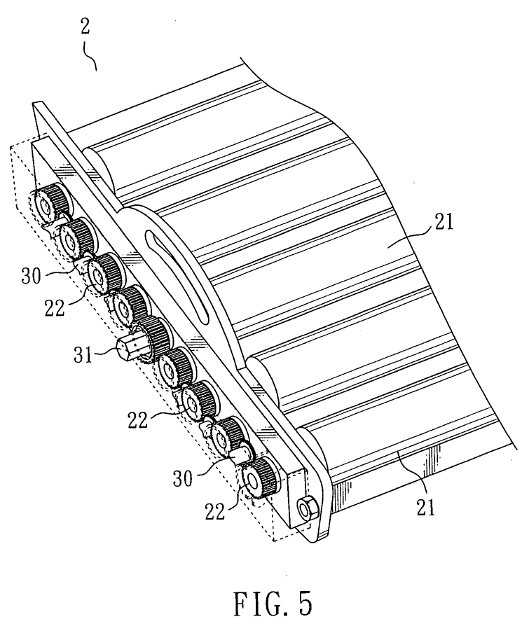

FIG. 6 is an exploded view of a part of the hotdog cooker according to the second embodiment of the present invention.

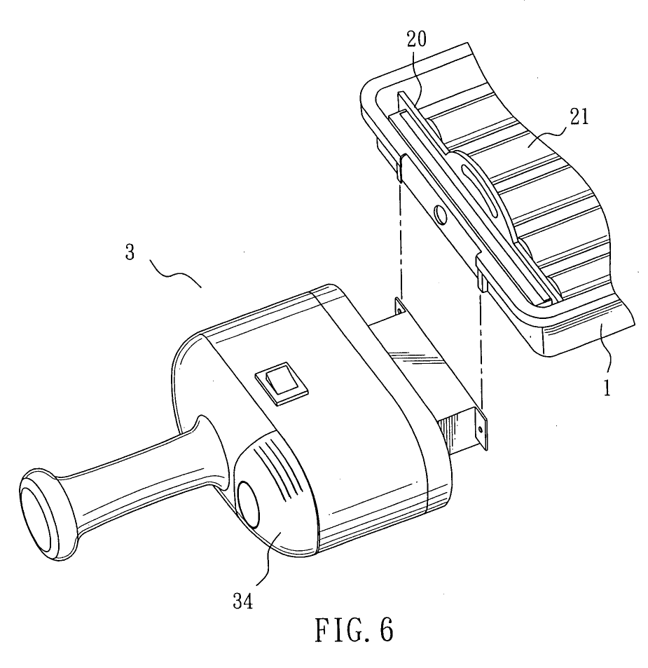

### DETAILED DESCRIPTION OF THE PREFERRED EMBODIMENT

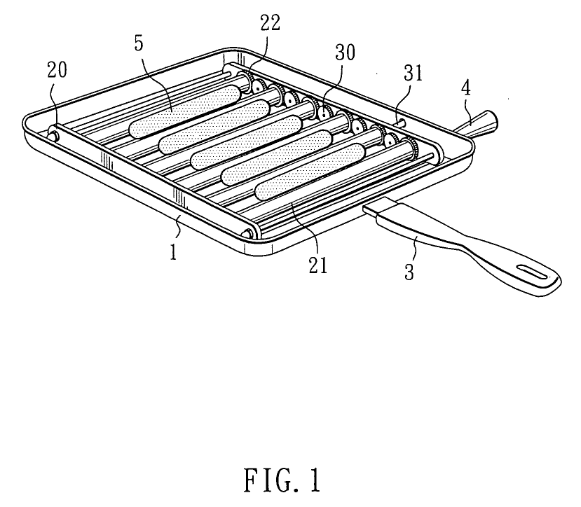

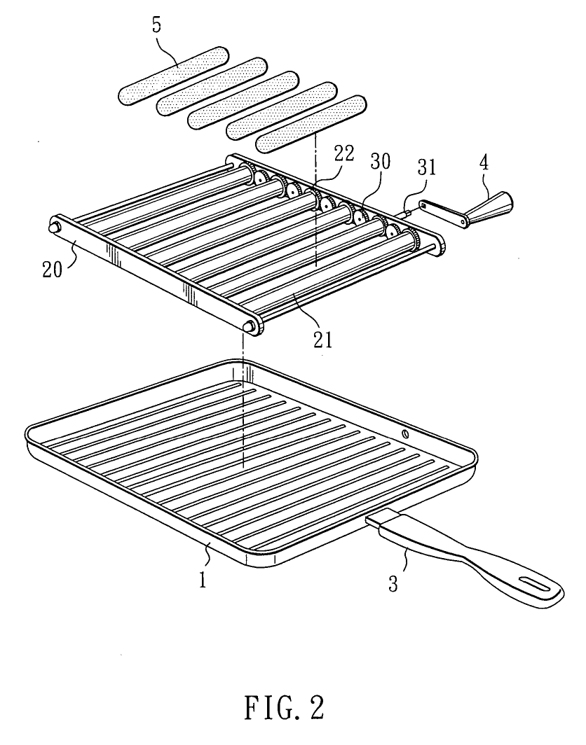

Referring to FIGS. 1 and 2, a hotdog cooker in accordance with the first embodiment of the present invention is shown comprised of a pan 1, a roller rack 2, a handle 3, and a driving member 4.

The pan 1 is a broad and shallow vessel for holding and cooking foods. The handle 3 is fixedly fastened to one side of the pan 1 The roller rack 2 comprises two side frame bars 20 arranged in parallel, a plurality of rollers 21 pivotally connected between the side frame bars 20 and arranged in parallel, a plurality of first gears 22 respectively fixedly mounted on the rollers 21 adjacent to one side frame bar 20, and a plurality of second gears 30 respectively meshed between the first gears 22 at each two adjacent rollers 21. The driving member 4 according to this embodiment is a crank handle 4 connected to the gear shaft 31 of one first gear 22. When the user operates the crank handle 4 to rotate the respective first gear 22 and the respect roller 21, and the other rollers 21 are rotated relative to the side frame bars 20 by means of the transmission action of the gears 22 and 30, and therefore the hotdogs 5 are respectively moved in between each two adjacent rollers 21.

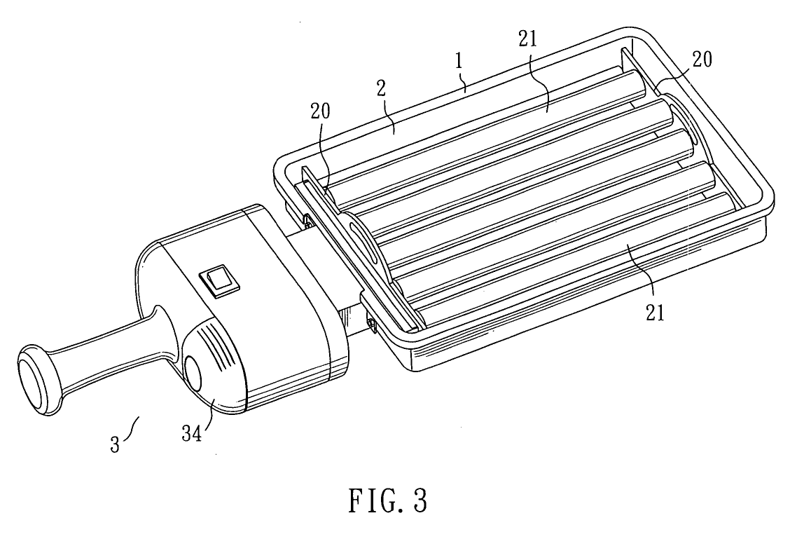

FIGS. 3˜6 show a hotdog cooker according to the second embodiment of the present invention. This embodiment is substantially similar to the aforesaid first embodiment with the exception of the use of a motor drive to substitute for the crank handle 4 for rotating the gear shaft 31. According to this embodiment, the motor drive comprises a DC motor 32 mounted in the handle 3, a battery chamber 34 defined in the handle 3, and a battery 35 mounted in the battery chamber 34 and electrically connected to the DC motor 32 (through an on/off switch). The DC motor 32 has an output shaft 33 coupled to the gear shaft 31. When started the DC motor 32 (switched on the on/off switch to start the DC motor 32), the output shaft 33 of the DC motor 32 drives the gear shaft 31 to rotate the respective roller 21, and therefore the rollers 21 are rotated to move the hotdogs 5.

A prototype of hotdog cooker has been constructed with the features of FIGS. 1˜6. The hotdog cooker functions smoothly to provide all the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A hotdog cooker comprising:
a pan;
a handle fixedly fastened to one side of said pan;
a roller rack for carrying hotdogs on said pan for cooking, said roller rack comprising two side frame bars arranged in parallel, a plurality of rollers pivotally connected between said side frame bars and arranged in parallel, a plurality of first gears respectively fixedly mounted on said rollers adjacent to one of said side frame bars, and a plurality of second gears respectively meshed between said first gears at each two adjacent rollers of said rollers; and
a driving means connected to a gear shaft of one of said first gears for rotating the respective first gear and the respective roller to drive said rollers to rotate.

2. The hotdog cooker as claimed in claim 1, wherein said driving means is a crank handle.

3. The hotdog cooker as claimed in claim 1, wherein said driving means is a battery-operated motor drive mounted in said handle.
